(19) United States
(12) Patent Application Publication
(10) Pub. No.: US 2002/0062374 A1
(43) Pub. Date: May 23, 2002

(54) Communications system, server, method for communications system, and recording medium

(75) Inventor: Tsuneyuki Kikuchi, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 09/988,785

(22) Filed: Nov. 20, 2001

(30) Foreign Application Priority Data
Nov. 22, 2000 (JP) 2000-355653

(51) Int. Cl. G06F 15/173

(52) U.S. Cl. 709/225; 709/226

(57) ABSTRACT

A communications system is provided that can be easily manipulated by users and does not require service providers to expand the system. The communication system includes a server, a client terminal, and a communications network linking them. The client terminal has means for transmitting a user identifier to connect the client terminal to the server. In the server, a disconnection condition table stores a user identifier and a service user specified by the user identifier, in conjunction with protocol information regarding contracted disconnection. The disconnection condition related to a user identifier received when the server is connected to the client terminal is retrieved from the disconnection condition table. The connection status to the client terminal is monitored. It is decided whether or not the connection status corresponds to the retrieved disconnection condition. If yes, the client terminal is disconnected.

### BACKGROUND OF THE INVENTION

The present invention relates to a communications system, a server, a method for the communications system, and a recording medium.

In data communications services including electronic mails or webs, the use charge is determined by a connection charge to a service provider or by a communication charge to a communication carrier. In the current charging system of service providers and communication carriers, the use charge depends on a communication time period, a communication distance, and a data volume, in addition to the base charge. Recently, in order to differentiate the charging system from other's charging systems, a flat-rate charging service, in which the use charge does not depend on the communication period and data volume, has been introduced. In future, this tends to be expanded broadly.

With the widespread proliferation of the flat-rate charging service, the case frequently occurs where a user left a client terminal to be linked to an application server although data is not being exchanged between them. This situation requires the service providers to expand the system to the extent that all the subscribers can use the services with all the lines connected at the same time. However, it is wasteful to increase the system in consideration with no transmission/reception of data because the system expansion leads to enormous investment and time.

In order to solve such a problem, the service provider is now trying an approach for automatically disconnecting a corresponding line when data does not flow in a communication path for a fixed time.

However, the user does not enjoy the merit of frequently disconnecting the communication line. It is troublesome for the user itself to reconnect the line. For that reason, the user always creates such a situation that data are flowing on the communication line. The method of disconnecting the corresponding line does not fully effective when data is not flowing on the communication line for a fixed time. As a result, this method cannot sufficiently suppress an expansion of the system.

### SUMMARY OF THE INVENTION

The present invention is made to solve the above-mentioned problems.

An object of the present invention is to provide a technique of capable of decreasing the complicated manipulation for connection by users and not requiring service providers to expand the system.

According to a first aspect of the present invention, a communications system comprises a server; a client terminal; and a communications network which interconnects the server and the client terminal. The client terminal includes means connected to the server, the means establishing communications with the server. The server includes a memory for storing information about disconnection condition regarding disconnection; decision means for monitoring a connection state between the client terminal and the server and deciding whether or not the connection corresponds to the disconnection condition; and disconnection means for disconnecting the client terminal when it is decided that the connection corresponds to said disconnection condition.

In another aspect of the invention, a communications system comprises a server; a client terminal; and a communications network which interconnects the server and the client terminal. The client terminal including means for transmitting a user identifier to issue a log-in request to the server. The server includes means for logging in to the client terminal in response to a log-in request from the client terminal; a memory for storing disconnection condition regarding disconnection in conjunction with the user identifier; retrieval means for retrieving the stored disconnection condition based on a user identifier transmitted from the client terminal; and disconnection means for monitoring a connection state between the client terminal and the server and disconnecting the client terminal when the connection corresponds to the disconnection condition.

In another aspect of the invention, a communications system comprises a server; a client terminal; and a communications network which interconnects the server and the client terminal. The client terminal includes means for transmitting a user identifier to issue a log-in request to the server. The server includes means for logging in to the client terminal in response to a log-in request from the client terminal; a memory for storing a disconnection condition regarding disconnection in conjunction with the user identifier; retrieval means for retrieving the stored disconnection condition based on a user identifier transmitted from the client terminal; decision means for monitoring a connection state between the client terminal and the server and deciding whether or not the connection corresponds to the disconnection condition; and disconnection means for disconnecting the client terminal when the connection corresponds to the disconnection condition.

In the communications system according to the invention, the memory stores a time period between logging-in and disconnection by a service user, in conjunction with a user identifier. The disconnection means comprises means for performing disconnection when a time elapsed from a log-in operation to the server from the client terminal exceeds a time period stored in the memory.

In the communications system according to the invention, the memory stores a non-communication time period for which data is not transmitted or received in conjunction with a user identifier. The disconnection means comprises means for performing disconnection when a non-communication time period of a client terminal exceeds the non-communication time period stored in the memory.

In the communications system according to the invention, the server is connected to an application server which stores an application supplied to a client terminal. The non-communication time period is a time period for which a packet is not communicated between a client terminal and an application server. The disconnection means comprises means for monitoring an arrival time of a packet being a group of the same transmission destination address and the same reception destination address and performing disconnection when a time period elapsed from the arrival time exceeds a non-communication time period stored in the memory.

In the communications system according to the invention, the memory stores an allowable simultaneous jointer count which can be simultaneously connected to an access point or server, in conjunction with a user identifier. The disconnection means comprises means for performing disconnection when the number of jointers connected to an access point or server exceeds the allowable simultaneous jointer count stored in the memory.

In the communications system according to the invention, the memory stores an allowable traffic allowable in a predetermined period of time, in conjunction with a user identifier. The disconnection means comprises means for performing disconnection when the traffic exceeds an allowable traffic stored in the memory.

In the communications system according to the invention, the memory stores a specific volume of data selected from the group of a transmission packet size, a reception packet size, a transmission packet count, and a reception packet count, in conjunction with a user identifier. The disconnection means comprises means for performing disconnection when a data volume of a packet being a group of the same transmission/reception destination address exceeds the specific volume.

In the communications system according to the invention, the server is connected to an application server which stores an application supplied from a client terminal. The memory stores an address of the application server and a timeout time, in conjunction with a service identifier. The disconnection means comprises means for monitoring an arrival time of a packet stored in the memory and performing disconnection immediately before elapsing a timeout time from the arrival time and with the timing a packet matching a group of an address and a service identifier is not received from an opposite party. The packet is a group of an address and a service identifier. The timeout time is stored in the memory in conjunction with a service identifier. The memory belongs to a group of a matching address and a matching service identifier.

In the communications system according to the invention, the disconnection means comprises means for disconnecting a client terminal logged in at an earliest time when two or more client terminals have the same disconnection condition.

In the communications system according to the invention, the memory stores a line disconnecting order in conjunction with a user identifier. The disconnection means is means for performing disconnection in accordance with the order stored in the memory.

Further another aspect of the invention relates to a communications method suitable for a communications system, the communications system comprising a server, a client terminal; and a communications network which interconnects the server and the client terminal. The client terminal performs the steps of connecting the client terminal to the server and establishing communications; monitoring a connection state between the client terminal and the server; deciding whether or not the connection corresponds to a disconnection condition, the disconnection condition regarding that connection stored in the memory is broken; and disconnecting the client terminal when it is decided that the connection corresponds to the disconnection condition.

Furthermore, the invention relates to a communications method suitable for a communications system, the communications system comprising a server, a client terminal, and a communications network which interconnects the server and the client terminal. The client terminal performs the step of transmitting a user identifier to issue a log-in request to the server. The server performs the steps of logging in to the client terminal in response to a log-in request from the client terminal; retrieving, based on a user identifier transmitted from the client terminal, a disconnection condition stored in conjunction to the user identifier; and monitoring a connection state of the client terminal; and disconnecting the client terminal when the connection corresponds to the disconnection condition.

In the communications method according to the invention, the memory stores a time period between logging-in and disconnection by a service user, in conjunction with a user identifier. The disconnection is performed when a time period elapsed from a log-in operation to the server from the client terminal exceeds a time period stored in the memory.

In the communications method according to the invention, the memory stores a non-communication time period for which data is not transmitted or received in conjunction with a user identifier. The disconnection is performed when a non-communication time period of a client terminal exceeds the non-communication time period stored in the memory.

In the communications method according to the invention, the server is connected to an application server which stores an application supplied to a client terminal. The non-communication time period is a time period for which a packet is not communicated between a client terminal and an application server. An arrival time of a packet being a group of the same transmission destination address and the same reception destination address is monitored. The disconnection is performed when a time period elapsed from the arrival time exceeds a non-communication time period stored in the memory.

In the communications method according to the invention, the memory stores an allowable simultaneous jointer count which can be simultaneously connected to an access point or server, in conjunction with a user identifier. The disconnection is performed when the number of jointers connected to an access point or server exceeds the allowable simultaneous jointer count stored in the memory.

In the communications method according to the invention, the memory stores an allowable traffic allowable in a predetermined period of time, in conjunction with a user identifier. The disconnection is performed when the traffic exceeds an allowable traffic stored in the memory.

In the communications method according to the invention, the memory stores a specific volume of data selected from the group of a transmission packet size, a reception packet size, a transmission packet count, and a reception packet count, in conjunction with a user identifier. The disconnection is performed when the data volume of a packet being a group of the same transmission/reception destination address exceeds the specific amount,

In the communications method according to the invention, the server is connected to an application server which stores an application supplied from a client terminal. The memory stores an address of the application server and a timeout time, in conjunction with a service identifier. The method further comprises the steps of monitoring an arrival time of a packet stored in the memory, the packet being a group of an address and a service identifier, and performing disconnection immediately before elapsing a timeout time from the arrival time, the timeout time being stored in the memory in conjunction with a service identifier, the memory belonging to a group of a matching address and a matching service identifier and with the timing a packet matching a group of an address and a service identifier is not received from an opposite party.

In the communications method according to the invention, a client terminal logged in at an earliest time is disconnected when two or more client terminals have the same disconnection condition.

In the communications method according to the invention, the memory stores a line disconnecting order in conjunction with a user identifier. The disconnection is performed in accordance with the order stored in the memory.

In another aspect, the invention relates to a server, which links to a client terminal based on a disconnection condition regarding disconnection of communications established between the server and a service user. The server comprises means for logging in to the client terminal in response to a log-in request from the client terminal; a memory for storing disconnection condition regarding disconnection in conjunction with the user identifier; retrieval means for retrieving the stored disconnection condition based on a user identifier transmitted from the client terminal; and disconnection means for monitoring a connection state between the client terminal and the server and disconnecting the client terminal when the connection corresponds to the disconnection condition.

In the server according to the invention, the memory stores a time period between logging in and disconnection by a service user, in conjunction with a user identifier. The disconnection means comprises means for performing disconnection when a time period elapsed from a log-in operation to the server from the client terminal exceeds a time period stored in the memory.

In the server according to the invention, the memory stores a non-communication time period for which data is not transmitted or received in conjunction with a user identifier. The disconnection means comprises means for performing disconnection when a non-communication time period of a client terminal exceeds the non-communication time period stored in the memory.

In the server according to the invention, the server is connected to an application server which stores an application supplied to a client terminal. The non-communication time period is a time period for which a packet is not communicated between a client terminal and an application server. The disconnection means comprises means for monitoring an arrival time of a packet being a group of the same transmission destination address and the same reception destination address and performing disconnection when a time period elapsed from the arrival time exceeds a non-communication time period stored in the memory.

In the server according to the invention, the memory stores an allowable simultaneous jointer count which can be simultaneously connected to an access point or server, in conjunction with a user identifier. The disconnection means comprises means for performing disconnection when the number of jointers connected to an access point or server exceeds the allowable simultaneous jointer count stored in the memory.

In the server according to the invention, the memory stores an allowable traffic allowable in a predetermined period of time, in conjunction with a user identifier. The disconnection means comprises means for performing disconnection when the traffic exceeds an allowable traffic stored in the memory.

In the server according to the invention, the memory stores a specific volume of data selected from the group of a transmission packet size, a reception packet size, a transmission packet count, and a reception packet count, in conjunction with a user identifier. The disconnection means comprises means for performing disconnection when a data volume of a packet being a group of the same transmission/reception destination address exceeds said specific volume.

In the server according to the invention, the server is connected to an application server which stores an application supplied from a client terminal. The memory stores an address of said application server and a timeout time, in conjunction with a service identifier. The disconnection means comprises means for monitoring an arrival time of a packet stored in the memory, the packet being a group of an address and a service identifier, and performing disconnection immediately before elapsing a timeout time from the arrival time, the timeout time being stored in the memory in conjunction with a service identifier, the memory belonging to a group of a matching address and a matching service identifier and with the timing a packet matching a group of an address and a service identifier is not received from an opposite party.

In the server according to the invention, the disconnection means comprises means for disconnecting a client terminal logged in at an earliest time when two or more client terminals have the same disconnection condition.

In the server according to the invention, the memory stores a line disconnecting order in conjunction with a user identifier. The disconnection means is means for performing disconnection in accordance with the order stored in the memory.

In another aspect, the invention relates to a recording medium in which a process program is stored, the process program controllably linking a server to a client terminal based on a disconnection condition regarding disconnection of communications established between the server and a service user. The process program comprises the steps of logging in to the client terminal in response to a log-in request from the client terminal; retrieving, based on a user identifier transmitted from the client terminal, a disconnection condition stored in conjunction to the user identifier; monitoring a connection state between the client terminal and the server; and disconnecting the client terminal when the connection corresponds to the disconnection condition.

In the recording medium according to the invention, a process program is stored for performing the disconnection when a time period elapsed from the time at which the client terminal logs in to the server exceeds a time period between logging-in and disconnection. The time period is stored in conjunction with a user identifier of a service user.

In the recording medium according to the invention, a process program is stored for performing the disconnection when a non-communication time period of a client terminal exceeds a non-communication time period for which data stored in conjunction with a user identifier of a service user is not transmitted or received.

In the recording medium according to the invention, a process program is stored for monitoring an arrival time of a packet having a group of the same transmission/reception destination addresses and performing the disconnection when a non-communication time period exceeds from the arrival time a predetermined non-communication time period for which a packet is not communicated between the client terminal and the application server.

In the recording medium according to the invention, a process program is stored for performing the disconnection when the number of users connected to an access point or server exceeds an allowable simultaneous jointer count which is simultaneously connectable to an access point or server. The allowable simultaneous jointer count is stored in conjunction with a user identifier.

In the recording medium according to the invention, a process program is stored for performing the disconnection when the traffic exceeds an allowable traffic allowable in a predetermined time period, the allowable traffic being stored in conjunction with a user identifier.

In the recording medium according to the invention, a process program is stored for performing the disconnection when the data volume of a packet having a group of the same transmission/reception destination addresses exceeds a specific volume of data selected from the group of a transmission packet size, a reception packet size, a transmission packet count, and a reception packet count, each being stored in conjunction with a user identifier.

In the recording medium according to the invention, the server stores a process program in a system connected to an application server which stores an application supplied to a client terminal, the process program for monitoring an arrival time of a packet being a group of an address and a service identifier, the packet being stored as a group of an address and a service identifier, and performing the disconnection immediately before a stored timeout time elapses from the arrival time and with the timing a packet is not received from an opposite party.

In the recording medium according to the invention, a process program is stored for performing disconnection from a client terminal logged in at an earliest time when two or more client terminals have the same disconnection condition.

In the recording medium according to the invention, a process program is stored for performing the disconnection in accordance with an order stored in conjunction with a user identifier.

### BRIEF DESCRIPTION OF THE DRAWINGS

This and other objects, features and advantages of the present invention will become more apparent from the following detailed description taken in conjunction with the attached drawings, in which:

FIG. 1 is a block diagram of a communications system;

FIG. 2 is a table listing disconnection conditions stored in a memory within a server, in conjunction with user identifiers;

FIG. 3 is a flowchart showing the system operation, with a disconnection condition parameter set to “communication time period”;

FIG. 4 is a flowchart showing the system operation with the disconnection condition parameter set to “non-communication time period”;

FIG. 5 is a flowchart showing the system operation with the disconnection condition parameter set to “data volume”;

FIG. 6 is a flowchart showing the system operation with the disconnection condition parameter set to “simultaneous jointer count”;

FIG. 7 is a flowchart showing the system operation with the disconnection condition parameter set to “traffic volume”; and

FIG. 8 is a flowchart showing an operation of automatically disconnecting a client terminal from a server immediately before a timeout occurs in an AP service.

### DESCRIPTION OF THE EMBODIMENTS

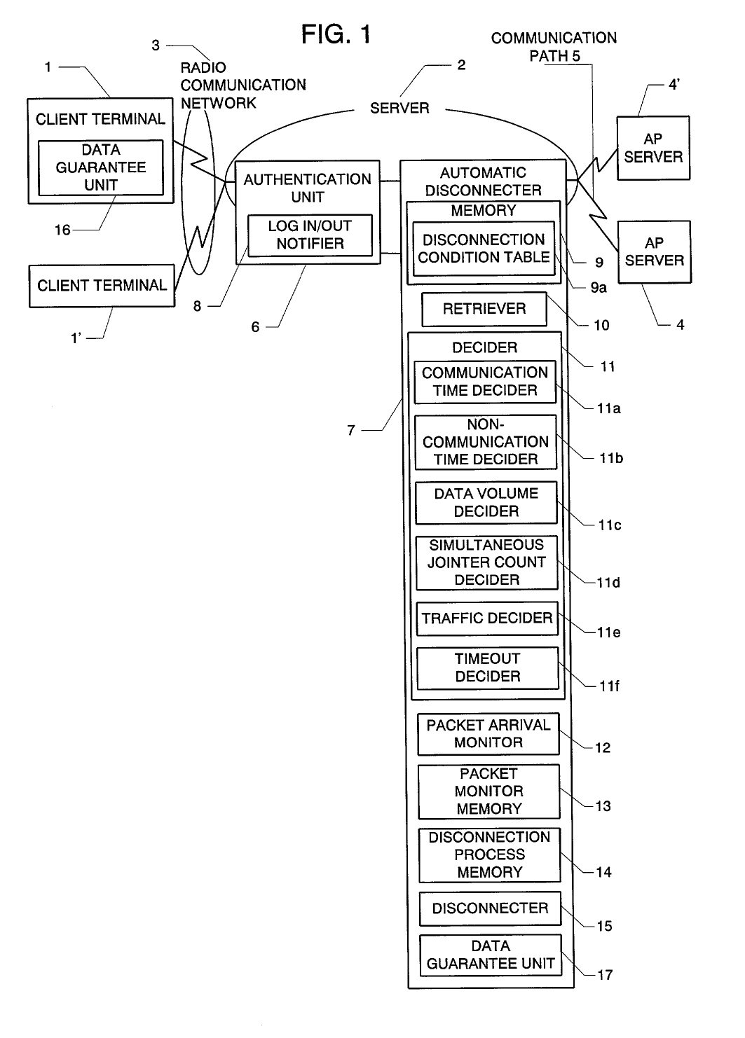

Preferred embodiments of the present invention will be described in detail below by referring to FIGS. 1 to FIG. 8.

Here, a communications system using the recently noted radio communications network will be explained as an example.

FIG. 1 is a block diagram illustrating a communications system.

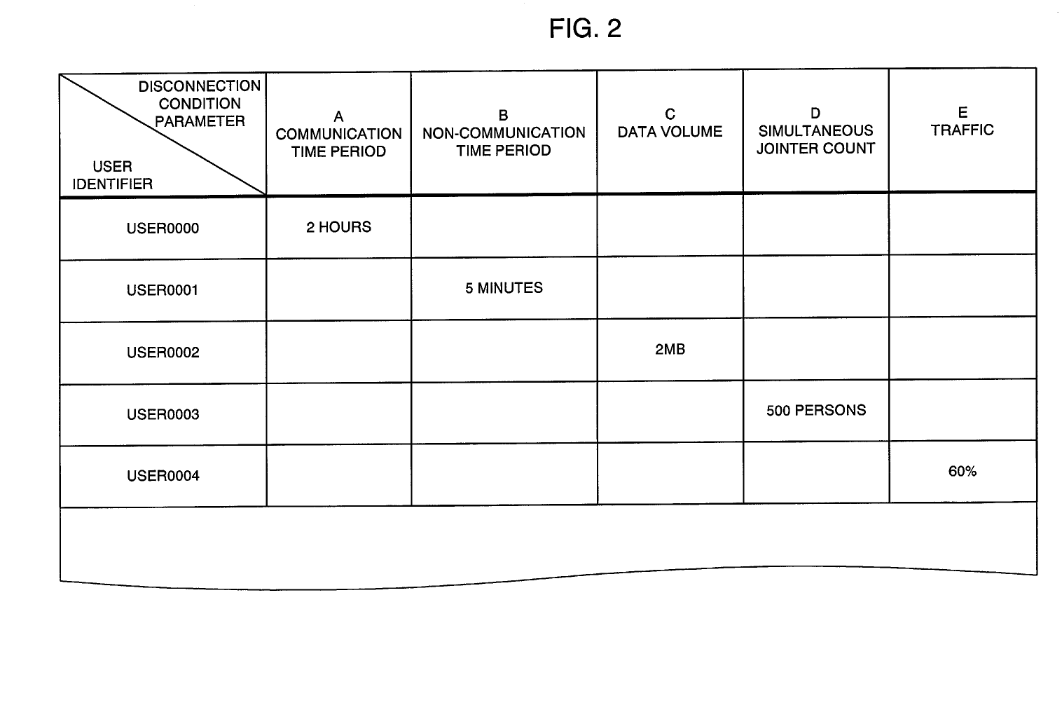

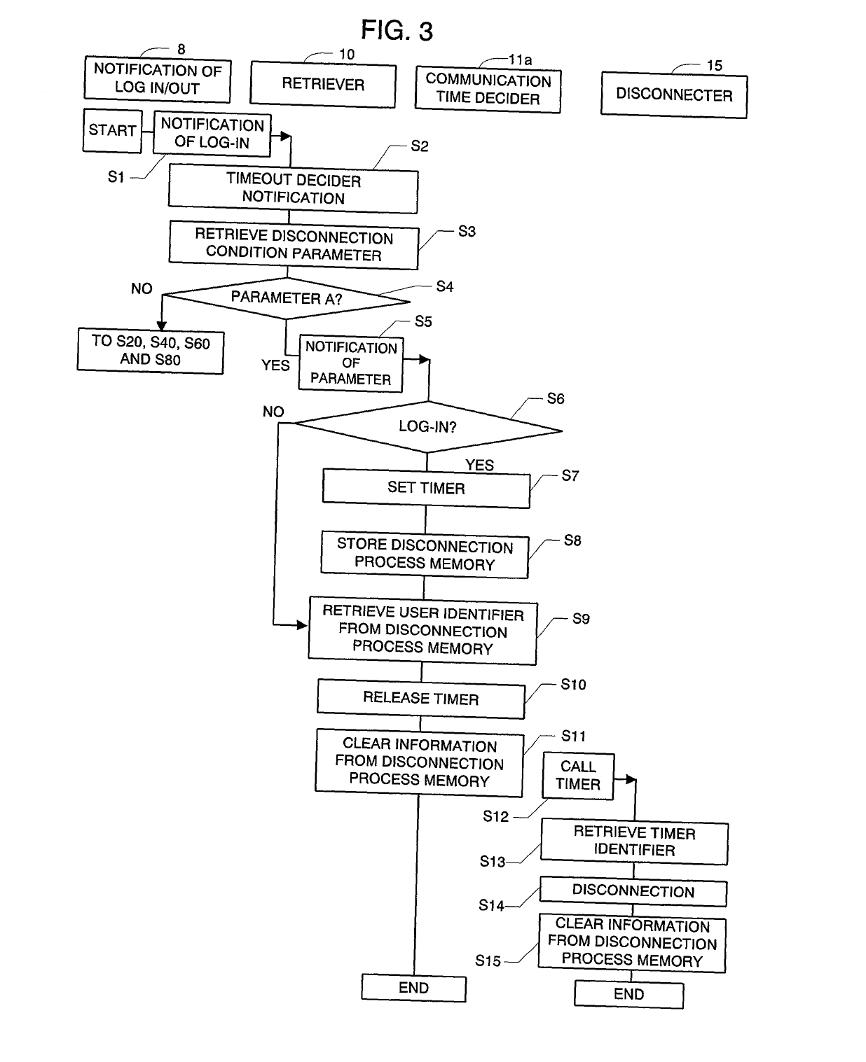

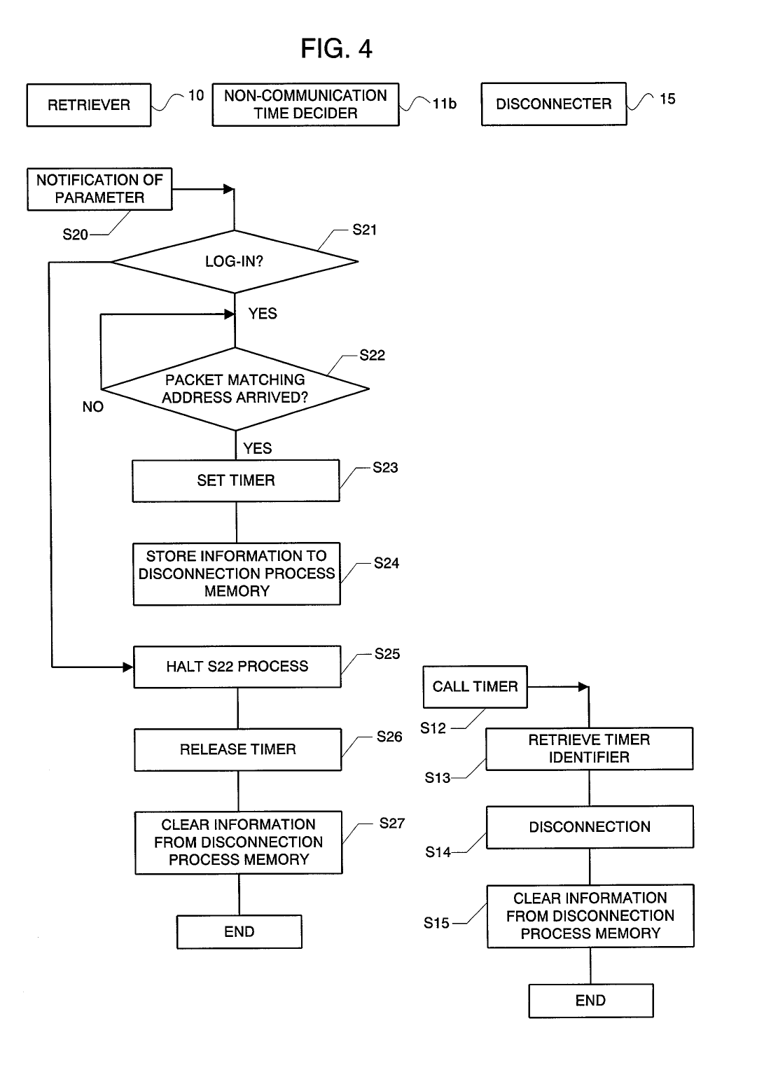

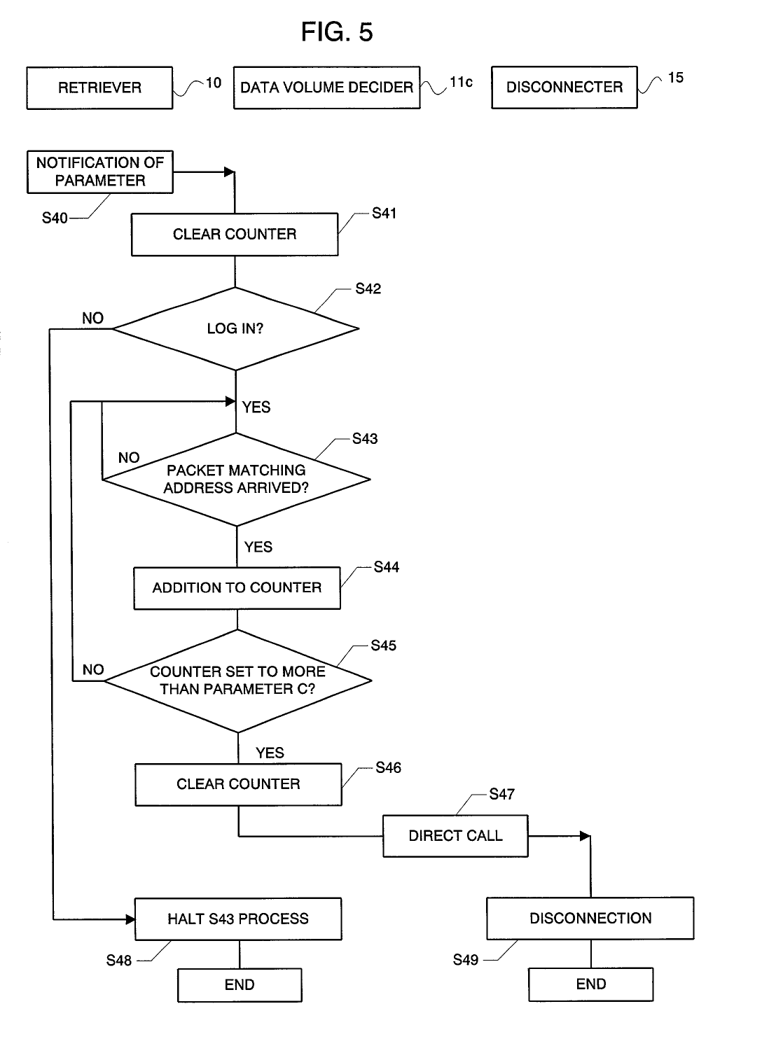

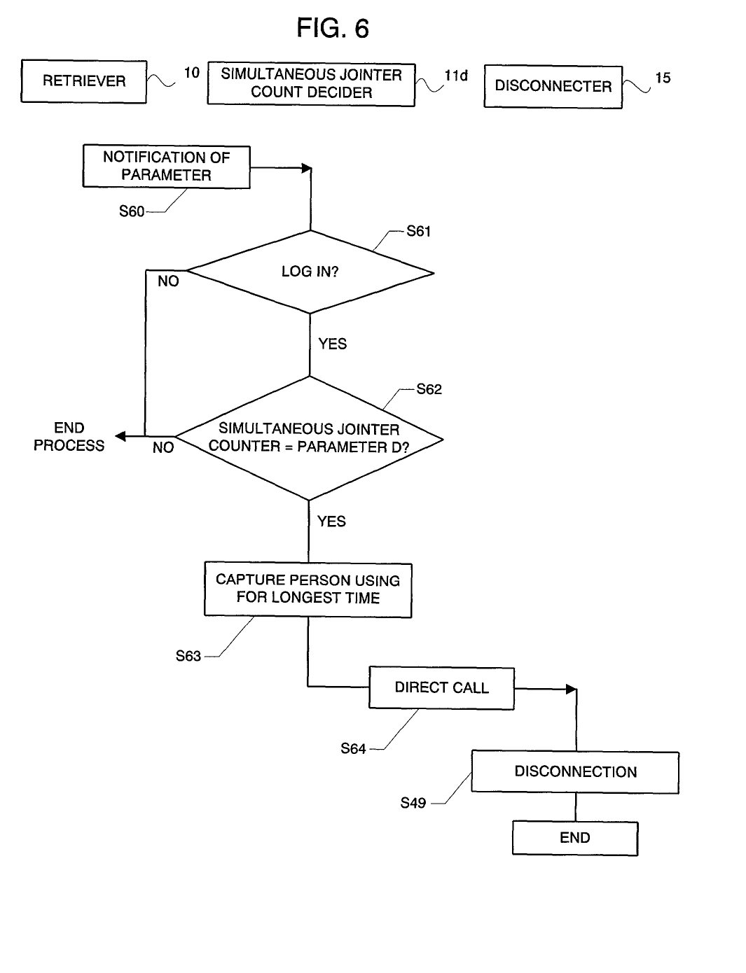

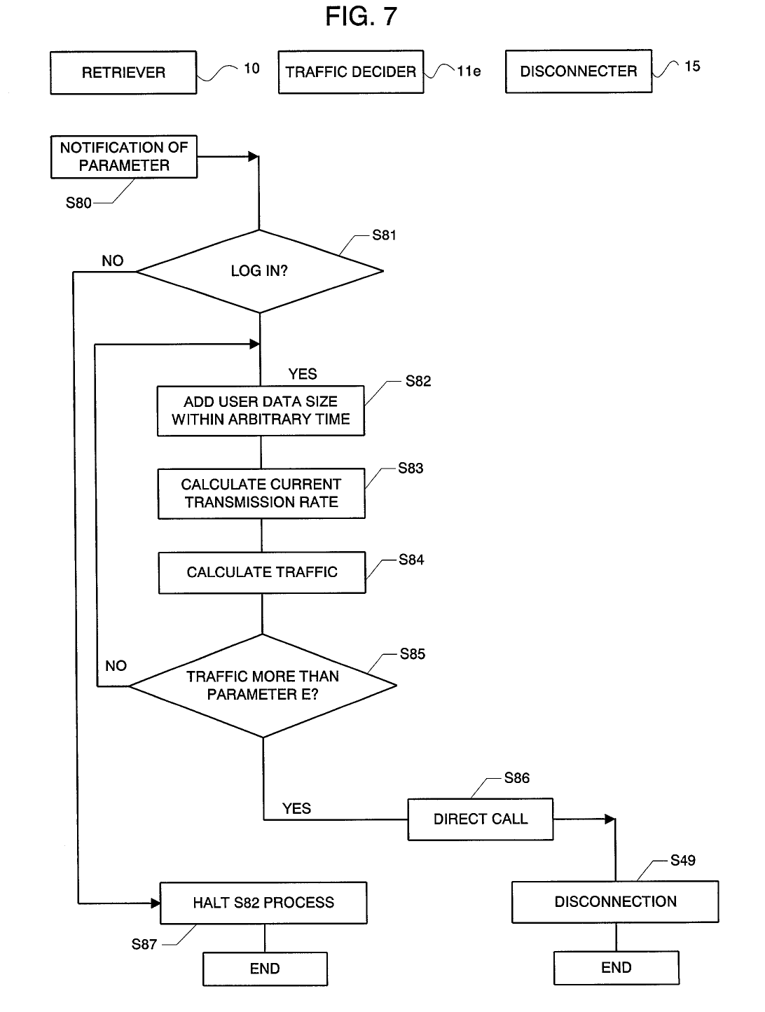

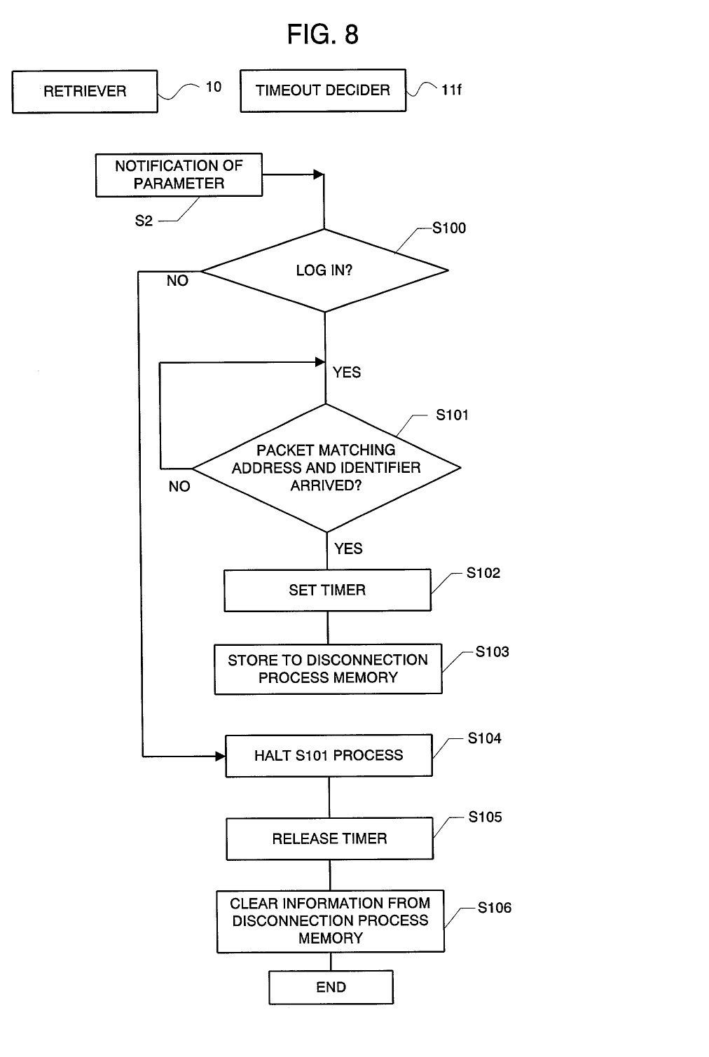

FIG. 2 is a table listing disconnection conditions stored in the memory within a server, in conjunction with user identifiers. FIG. 3 is a flowchart showing the system operation with a disconnection condition parameter set to “communication time period”. FIG. 4 is a flowchart showing the system operation with a disconnection condition parameter set to “non-communication time period”. FIG. 5 is a flowchart showing the system operation with a disconnection condition parameter set to “data volume”. FIG. 6 is a flowchart showing the system operation with a disconnection condition parameter set to “simultaneous jointer count”. FIG. 7 is a flowchart showing the system operation with a disconnection condition parameter set to “traffic”. FIG. 8 is a flowchart showing the system operation of automatically disconnecting a line between a client terminal and a server immediately before a timeout occurs in an AP service.

This communications system consists of a client terminal 1, a server 2, a communications network (or a radio communications network) 3 through which the client terminal and the server are interconnected, an application server (abbreviated as AP server) 4, and a communications network 5 through which the server 2 and the AP server 4 are interconnected.

At the client terminal 1, a communication service user makes a contract with a service provider and receives various services from the AP server 4. Specifically, the client terminal corresponds to a mobile telephone or a personal computer provided with a radio communication function.

The AP server 4 stores an application supplied to a user from a service provider. The server 2 includes an authentication unit 6 and an automatic disconnecter 7.

The authentication unit 6 is a server that checks for the presence or absence of a contract agreed by a communication service user and the content of the contract. The authentication 6 includes a log-in/out notifier 8. With the timing at which a service user has logged in/out to the server 6, the log-in/out notifier 8 notifies the automatic disconnecter 7 of a log-in/out type, a user identifier, an address of a client terminal (hereinafter referred to as a terminal address) allocated by a user itself, and an identifier of a connected line (hereinafter referred to as a line identifier).

The automatic disconnecter 7 includes a memory 9, a retriever 10, a decider 11, a packet arrival monitor 12, a packet monitor memory 13, a disconnection process memory 14, and a disconnecter 15.

The memory 9 stores a disconnection condition table 9a listing user identifiers in conjunction with disconnection condition parameters.

The retriever 10 retrieves the decider 11 based on login/out information.

The decider 11 decides whether or not to disconnect a line in accordance with a disconnection parameter and a use status. The decider 11 includes a communication time decider 11a, a non-communication time decider 11b, a data volume decider 11c, a simultaneous jointer count decider 11d, a traffic decider 11e, and a timeout decider 11f. The retriever 10 retrieves a decider in accordance with a disconnection condition parameter.

The packet arrival monitor 12 monitors an arrival of a packet transmitted from the AP server 4 to the client terminal 1. The packet monitor memory 13 stores the detail of an arrived packet. The disconnection process memory 14 stores information regarding a disconnection process. The disconnecter 15 disconnects the line between the client terminal 1 and the server 2. The AP server 4 stores an application supplied to a user from a service provider.

FIG. 2 shows an example of the disconnection condition table 9a.

The disconnection condition table 9a has as items a user identifier and a disconnection condition parameter including user identifier. The disconnection condition parameter includes communication time period (A), non-communication time period (B), data volume (C), simultaneous jointer count (D), and traffic (E). Each disconnection condition parameter is arbitrarily selected and set at the time of making a contract between a service user and a service provider. In some service charge plans, no disconnection condition parameters may be set or plural disconnection condition parameters may be set.

Connection means that a client terminal and a server are interconnected via a communications line to exchange data. For example, connection means that a client terminal is logged in to a server. Disconnection means that data cannot be exchanged. For example, disconnection means that a client terminal is logged out from a server.

Next, the operation of the present invention will be described below by referring to FIG. 3.

Referring to FIG. 3, a communication service user makes a contact with a service provider on disconnection conditions (in this example, a disconnection parameter corresponds to the communication time period (A)). Using the client terminal 1, the communication service user receives contents from the AP server 4 via the radio communication network 3 and the server 2.

Using the client terminal 1, the communication service user logs in to the authentication unit 6 via the radio communication network 3. In this case, the client terminal 1 transmits a user identifier and the address of the client terminal 1 to the authentication unit 6. After the client terminal 1 has logged in to the authentication unit 6, the authentication unit 6 adds a line identifier to the line through which the client terminal 1 has connected to the authentication unit 6.

The log-in/out notifier 8 notifies the retriever 10 of a log-in/out type, a user identifier, a terminal address, and a line identifier, with the timing at which the client terminal 1 logs in/out to the authentication unit 6 (S1). The step S2 will be described later.

The retriever 10 retrieves a disconnection condition parameter set in the disconnection condition table 9a based on the user identifier received from the log in/out notifier 8 (S3).

Whether or not the retrieved disconnection condition parameter corresponds to the communication time period A is decided (S4).

With the disconnection condition parameter A, the flow goes to the step S5. With the disconnection condition parameter B, the flow goes to the step S20. With the disconnection condition parameter C, the flow goes to the step S40. With the disconnection condition parameter D, the flow goes to the step S60. With the disconnection condition parameter E, the flow goes to the step S80.

In the step S5, the log in/out notifier 8 notifies the communication time decider 11a of a log in/out type, a user identifier, the address of the client terminal 1, a line identifier, data about the disconnection condition parameter A stored in the disconnection condition table 9a.

The communication time decider 11a ascertains the log in/out type (S6). In the case of the log-in type, the flow goes to the step S7. In the case of the log-out type, the flow goes to the step S9. In the step S7, the communication time decider 11a sets the timer in such a manner that the timer issues a call signal after a communication time period (e.g. two hours in FIG. 2) set to the disconnection condition parameter A. The disconnection process memory 14 stores a user identifier, a line identifier, and a set-timer identification value (hereinafter referred to as a timer identifier) (S8).

The disconnecter 15 retrieves a timer identifier from the disconnection process memory 14 (S13) in response to the call signal from the timer (S12) and disconnects the client terminal 1 indicated by the line identifier in a set mode (S14). After disconnection, the disconnecter 15 clears user identifier data, line identifier data, and timer identifier data in the disconnection process memory 14 (S15).

In the logging-out, the communication time decider 11a retrieves a user identifier from the disconnection process memory 14 (S9) and then releases the timer in the set mode (S10). Thus the communication time decider 11a clears the user identifier data, the line identifier data, and the timer identifier data from the disconnection process memory 14 (S11).

In summary of the above-mentioned example, a communications system user makes a contract regarding a communication time period with a service provider. A time beyond the contracted communication time period is automatically judged. The corresponding terminal is automatically disconnected based on the judgement.

The operation of the present invention, with the disconnection condition parameter “B” set to “non-communication time period”, will be described below by referring to FIG. 4.

The packet arrival monitor 12 stores a packet arrival time transmitted from the client terminal 1 or the AP server 4 and control information described in a packet header, to the packet monitor memory 13 every packet arrival. The control information relates to, for example, a transmission destination address, a received destination address, a service identifier, a user data size, and the like.

In the step S20, the retriever 10 notifies the non-communication time decider 11b of the log-in/out type, the user identifier, the address of the client terminal 1, the line identifier, and data regarding the disconnection condition parameter B.

The non-communication time decider 11b ascertains the log-in/out type (S21). In the case of the log-in type, the flow goes to the step S22. In the case of the log-out type, the flow goes to the step S25. Whether or not information about a packet including the transmission destination address matching the terminal address or the reception destination address matching the terminal address has been output to the packet monitor memory 13 is confirmed in the step S22. The non-communication time decider 11b brings the flow to the step S23 in the case of Yes and the flow back to the step S22 in the case of No. In the step S23, after the non-communication time period (e.g. five minutes in FIG. 2) has passed, the timer is set to the call mode. The user identifier, the line identifier, and the timer identifier are stored into the disconnection process memory 14 (step S24).

Similarly, when being called from the timer (S12), the disconnecter 15 retrieves the timer identifier from the disconnection condition memory 14 (S13) and disconnects the client terminal 1 indicated by the line identifier in the set mode (S14). After disconnection, the disconnecter 15 clears the user identifier, the line identifier, and the timer identifier from the disconnection process memory 14 (S15).

In the log-out mode, the non-communication time decider 11b halts the process in the step S22 (S25) and retrieves a user identifier from the automatic disconnection process memory, thus releasing the timer in the set mode (S26). Thus, the user identifier data, the line identifier data, and the timer identifier data are cleared from the automatic disconnection process memory 14 (S27).

In summary of the above-mentioned example, a communication system user makes a contract regarding a non-communication time period with a service provider. A time beyond the contracted non-communication time period is automatically retrieved. The corresponding terminal is automatically disconnected through the retrieval.

Next, the operation of the present invention, with the disconnection condition parameter “C” set to “data volume”, will be described later by referring to FIG. 5.

In the step S40, the retriever 10 notifies the data volume decider 11c of a log-in/out type, a user identifier, a terminal address, a line identifier, and data to which the disconnection condition parameter C is set.

The data volume decider 11c clears the data volume counter (S41) and then ascertains a log-in/out type (S42). In the case of a log-in mode, the flow goes to the step S43. In the case of a log-out mode, the flow goes to the step S48.

In the step S43, the data volume decider 11c ascertains whether or not the packet monitor memory 12 has received information on a packet which contains a transmission destination address and a reception destination address each matching a terminal address.

If Yes, the flow goes to the step S44. If No, the flow goes to the step S43. In the step S44, the data volume decider 11c adds a user data size output from the packet monitor memory 11 to the data volume counter. Thus, the data volume decider 11c ascertains whether or not the data volume counter is filled with the data volume (2 MB in FIG. 2) or more set to the disconnection condition parameter C (S45).

If Yes, the flow goes to the step S46. If No, the flow goes to the step S43. In the step S46, the data volume decider 11c clears the data volume counter and calls the disconnecter 15 with an argument acting as a line identifier (S47). In the step S48, the data volume decider 11c halts the process in the step S43.

When being called from the data volume decider 11c (S47), the disconnecter 15 disconnects the client terminal indicated with the line identifier handed over as an argument (S49).

In summary of the above-mentioned example, a communication system user makes a contract regarding a data volume with a service provider. A volume beyond the contracted data volume is automatically judged. The corresponding terminal is automatically disconnected based on the judgement.

Next, the operation of the present invention, with the disconnection condition parameter “D” set to “simultaneous jointer count”, will be described below by referring to FIG. 6.

In the step S60, the retriever 10 notifies the simultaneous jointer count decider 11d of a log-in/out type, a user identifier, a terminal address, a line identifier, and a simultaneous jointer count (500 persons in FIG. 2) set to the disconnection condition parameter D.

With the timing at which a log-in type is received from the log-in/out notifier 8, the retriever 10 increments simultaneous jointer counter one by one and holds a log-in time, a user identifier data, and a line identifier data. Alternatively, with the timing at which a log-out type is received, the retriever 10 subtracts the simultaneous jointer counter one by one and erases a log-in time, user identifier data, and line identifier data.

The simultaneous jointer count decider 11d ascertains the log-in/out type (S61). In the log-in mode, the flow goes to the step S62. In the log-out mode, the process of the simultaneous jointer count decider is ended. In the step S62, the simultaneous jointer count decider 11d decides whether or not a simultaneous jointer count is equal to the number of connectors, which are allowed simultaneously.

If Yes, the flow goes to the step S63. If No, the process of the simultaneous jointer count decider 11d ends. In the step S63, the simultaneous jointer count decider 11d captures the line identifier of a user corresponding to an earliest log-in time, which is stored in the retrieval memory 10. Then, the simultaneous jointer count decider 11d calls the disconnecter 15 for the captured identifier as an argument (S64).

When being called from the simultaneous jointer count decider 11d, the disconnecter 15 disconnects the client terminal indicated with the line identifier handed over as an argument (S49).

In summary of the above-mentioned example, a communication system user makes a contract regarding a simultaneous jointer count with a service provider. Exceeding the contracted simultaneous jointer count is automatically judged. The corresponding terminal is automatically disconnected based on the judgement.

Under the situation of the service provider, a simultaneous jointer count corresponds to the number of jointers to be connected to the same access point or the number of connectors to be connected to the same server.

Next, the operation of the present invention, with the disconnection condition parameter “E” set to “traffic”, will be described below by referring to FIG. 7.

In the step S80, the retriever 10 notifies the traffic decider 11e of a log-in/out type, a user identifier, a terminal address, a line identifier, and a traffic (60% in FIG. 2) set to the disconnection condition parameter E.

The traffic decider 10e ascertains a log-in/out type (S81). In the log-in mode, the flow goes to the step S82. In the log-out mode, the flow goes to the step S87. In the step S82, the traffic decider 10e adds the user data size output to the packet monitor memory 12 at arbitrary time intervals to calculate a current transmission rate (S83). Thus, the ratio (traffic) of the current transmission rate to the maximum transmission rate of a predetermined communication path is calculated (S84). Moreover, the traffic decider 10e judges whether or not the traffic exceeds a value set to the disconnection condition parameter E (S85). If Yes, the flow goes to the step S86. If No, the flow goes to the step S82.

In the step S86, the traffic decider 10e calls the disconnector 15 for a line identifier acting as an argument. When being called from the traffic decider 11e (S86), the disconnector 15 disconnects the client terminal shown with the line identifier handed over as an argument (S49). After disconnection from the client terminal, the traffic decider 10e halts the process of the step S82 (S87).

When the log out is decided in the step S81, the traffic decider 10e halts the process of the step S82 (S87).

In summary of the above-mentioned example, a communication system user makes a contract regarding traffic with a service provider. An amount beyond the contracted traffic is automatically judged. The corresponding terminal is automatically disconnected based on the judgement.

In the AP service, the timeout time is set in such a way that the same user does not use the line over a predetermined fixed period of time. When the timeout time has passed, the line is often automatically disconnected. While a user is downloading a software program, the line may be cut because of timeout, so that data during reception cannot be guaranteed. In such a case, reconnecting and re-downloading have to be tried from the first. Such procedure is inconvenient to service users and service providers.

In order to solve the above-mentioned inconvenience, the operation of the present invention, wherein the line is disconnected immediately before timeout occurs at an AP point, will be described below by referring to FIG. 8.

The timeout decider 11f previously captures an AP server address from the AP server 4 and a service identifier and timeout time supplied by the AP server 4 and stores them into the memory 9 in conjunction with service identifiers. When receiving notification from the retriever 10 (S2 in FIG. 3), the timeout decider 11f ascertains a log-in/out type (S100). In the log-in mode, the flow goes to the step S101. In the log-out mode, the flow goes to the step S104.

In the Step S101, the timeout decider 11f checks the packet information output from the packet monitor memory 13. This judgement is carried out on whether or not a group of an originating destination address and a service identifier described in packet information output to the packet monitor memory 13 matches a group of an AP server address and a service identifier stored in the memory 9.

The timeout decider 11f brings, if Yes, the process to the step S102 and brings, if No, the process to the step S101.

In the step S102, the timeout decider 11f sets the timer to call it immediately before the timeout time and then stores user identifier data and line identifier data, and timer identifier data into the disconnection process memory 14 (S103).

Similarly, when being called from the timer (S12), the disconnecter 15 retrieves a timer identifier from the disconnection process memory (S13) and disconnects the client terminal indicated with the line identifier in a set mode (S14). Thus, the disconnecter 15 clears user identifier data, line identifier data, and timer identifier data in the disconnection process memory 14 (S15).

When it is judged that the log-out operation is over in the step S100, the timeout decider 11f halts the step S101 process in the step S104 and retrieves the user identifier from the disconnection process memory 14, thus releasing the timer in the set mode (S105). Thus, the timeout decider 11f clears user identifier data, line identifier data, and timer identifier data in the automatic disconnection process memory 14 (S106).

In summary, the example has been described of automatically disconnecting the line immediately before a timeout occurs in an AP service.

Next, the operation where data is guaranteed in a disconnection mode will be described below.

The client terminal 1 includes a data guarantee unit 16 while the automatic disconnecter 7 includes a data guarantee unit 17 (refer to FIG. 1).

Each of the data guarantee units 16 and 17 includes a buffer memory. In the data guarantee units 16 and 17, a sequence number is attached to the header of a packet to be transmitted. A packet with a sequence number to be transmitted is stored in the buffer memory. The buffer memory stores the transmission confirmation packet until a transmission confirmation packet with the same sequence number is received from the transmission destination.

In the above-described configuration, even if the disconnecter automatically disconnects a client terminal during data communication, transmission can be resumed from data following the previously transmitted data after reconnection.

In the above description, the authentication unit 6 and the automatic disconnection server 7 are disposed in the system. The automatic disconnection server 7 may be formed of hardware as an automatic disconnecter.

For easy understanding, one disconnection condition parameter has been explained. However, plural disconnection condition parameters may be combined and set. In such a case, when the condition of any one of the disconnection condition parameters is satisfied, a corresponding client terminal is disconnected.

When there are two or more service users judged by the decider based on a certain disconnection condition parameter, the log-in times are recorded. Thus, the disconnecter can disconnect the client terminal of the user belonging to the earliest log-in time.

Alternatively, with two or more service users decided by the decider based on a certain disconnection condition parameter, the disconnection condition table stores disconnection orders in connection to user identifiers.

The disconnecter may disconnect the client terminal with a highest disconnection order based on the stored orders. The communications system has been described above. The present invention can be applied to the communication method. Moreover, the present invention can be partially applied only to the server. Moreover, a server control process program, recorded on a recording medium, can be installed to the server.

A radio communications network has been described in the above embodiment. Similarity, the radio communication network can be applied to cable communications networks, local-area networks, and the like.

As described above, according to the present invention, the technique can be provided that can simplify the manipulation of service users and does not require service providers to expand the system.

The entire disclosure of Japanese Application No. 2000-355653 filed Nov. 22, 2000 including specification, claims, drawings and summary are incorporated herein by reference in its entirely.

What is claimed is:

1 A communications system comprising:
a server;
a client terminal; and
a communications network which interconnects said server and said client terminal;
said client terminal including means connected to said server, said means establishing communications with said server;
said server including:
a memory for storing information about disconnection condition regarding disconnection;
decision means for monitoring a connection state between said client terminal and said server and deciding whether or not said connection corresponds to said disconnection condition; and
disconnection means for disconnecting said client terminal when it is decided that said connection corresponds to said disconnection condition.

2 The communications system defined in claim any one of claim 1, wherein said disconnection means comprises means for disconnecting a client terminal logged in at an earliest time when two or more client terminals have the same disconnection condition.

3 A communications system comprising:
a server;
a client terminal; and
a communications network which interconnects said server and said client terminal;
said client terminal including means for transmitting a user identifier to issue a log-in request to said server;
said server including:
means for logging in to said client terminal in response to a log-in request from said client terminal;
a memory for storing disconnection condition regarding disconnection in conjunction with said user identifier;
retrieval means for retrieving said stored disconnection condition based on a user identifier transmitted from said client terminal; and
disconnection means for monitoring a connection state between said client terminal and said server and disconnecting said client terminal when said connection corresponds to said disconnection condition.

4 The communications system defined in claim 2, wherein said disconnection means further comprising:
decision means for monitoring a connection state between said client terminal and said server and deciding whether or not said connection corresponds to said disconnection condition; and
disconnection means for disconnecting said client terminal when said connection corresponds to said disconnection condition.

5 The communications system defined in claim 3, wherein said memory stores a time period between logging-in and disconnection by a service user, in conjunction with a user identifier; and wherein said disconnection means comprises means for performing disconnection when a time period elapsed from a log-in operation to said server from said client terminal exceeds a time period stored in said memory.

6 The communications system defined in claim 3, wherein said memory stores a non-communication time period for which data is not transmitted or received in conjunction with a user identifier; and wherein said disconnection means comprises means for performing disconnection when a non-communication time period of a client terminal exceeds said non-communication time period stored in said memory.

7 The communications system defined in claim 6, wherein said server is connected to an application server which stores an application supplied to a client terminal; and wherein said non-communication time period is a time period for which a packet is not communicated between a client terminal and an application server; and wherein said disconnection means comprises means for monitoring an arrival time of a packet being a group of the same transmission destination address and the same reception destination address and performing disconnection when a time period elapsed from said arrival time exceeds a non-communication time period stored in said memory.

8 The communications system defined in claim 3, wherein said memory stores an allowable simultaneous jointer count which can be simultaneously connected to an access point or server, in conjunction with a user identifier; and wherein said disconnection means comprises means for performing disconnection when the number of jointers connected to an access point or server exceeds the allowable simultaneous jointer count stored in said memory.

9 The communications system defined in claim 3, wherein said memory stores an allowable traffic allowable in a predetermined period of time, in conjunction with a user identifier; and wherein said disconnection means comprises means for performing disconnection when said traffic exceeds an allowable traffic stored in said memory.

10 The communications system defined in claim 3, wherein said memory stores a specific volume of data selected from the group of a transmission packet size, a reception packet size, a transmission packet count, and a reception packet count, in conjunction with a user identifier; and wherein said disconnection means comprises means for performing disconnection when a data volume of a packet being a group of the same transmission/reception destination address exceeds said specific volume.

11 The communications system defined in claim 3, wherein said server is connected to an application server which stores an application supplied from a client terminal; and wherein said memory stores an address of said application server and a timeout time, in conjunction with a service identifier; and wherein said disconnection means comprises means for monitoring an arrival time of a packet stored in said memory, said packet being a group of an address and a service identifier, and performing disconnection immediately before elapsing a timeout time from said arrival time, said timeout time being stored in said memory in conjunction with a service identifier, said memory belonging to a group of a matching address and a matching service identifier and with the timing a packet matching a group of an address and a service identifier is not received from an opposite party.

12 The communications system defined in claim 3, wherein said disconnection means comprises means for disconnecting a client terminal logged in at an earliest time when two or more client terminals have the same disconnection condition.

13 The communications system defined in claim 3, wherein said memory stores a line disconnecting order in conjunction with a user identifier; and wherein said disconnection means is means for performing disconnection in accordance with the order stored in said memory.

14 A communications method suitable for a communications system, said communications system comprising a server, a client terminal; and a communications network which interconnects said server and said client terminal, said client terminal performing the steps of:
connecting said client terminal to said server and establishing communications;
monitoring a connection state between said client terminal and said server;
deciding whether or not said connection corresponds to a disconnection condition, said disconnection condition regarding that connection stored in said memory is broken; and
disconnecting said client terminal when it is decided that said connection corresponds to said disconnection condition.

15 The communications method defined in claim 14, wherein a client terminal logged in at an earliest time is disconnected when two or more client terminals have the same disconnection condition.

16 A communications method suitable for a communications system, said communications system comprising a server, a client terminal, and a communications network which interconnects said server and said client terminal;
said client terminal performing the step of:
transmitting a user identifier to issue a log-in request to said server;
said server performing the steps of:
logging in to said client terminal in response to a log-in request from said client terminal;
retrieving, based on a user identifier transmitted from said client terminal, a disconnection condition stored in conjunction to said user identifier; and
monitoring a connection state of said client terminal; and
disconnecting said client terminal when said connection corresponds to said disconnection condition.

17 The communications method defined in claim 16, wherein said memory stores a time period between logging-in and disconnection by a service user, in conjunction with a user identifier; and wherein said disconnection is performed when a time period elapsed from a log-in operation to said server from said client terminal exceeds a time period stored in said memory.

18 The communications method defined in claim 16, wherein said memory stores a non-communication time period for which data is not transmitted or received in conjunction with a user identifier; and wherein said disconnection is performed when a non-communication time period of a client terminal exceeds said non-communication time period stored in said memory.

19 The communications method defined in claim 18, wherein said server is connected to an application server which stores an application supplied to a client terminal; and wherein said non-communication time period is a time period for which a packet is not communicated between a client terminal and an application server; and wherein an arrival time of a packet being a group of the same transmission destination address and the same reception destination address is monitored and said disconnection is performed when a time period elapsed from said arrival time exceeds a non-communication time period stored in said memory.

20 The communications method defined in claim 16, wherein said memory stores an allowable simultaneous jointer count which can be simultaneously connected to an access point or server, in conjunction with a user identifier; and wherein said disconnection is performed when the number of jointers connected to an access point or server exceeds the allowable simultaneous jointer count stored in said memory.

21 The communications method defined in claim 16, wherein said memory stores an allowable traffic allowable in a predetermined period of time, in conjunction with a user identifier; and wherein said disconnection is performed when said traffic exceeds an allowable traffic stored in said memory.

22 The communications method defined in claim 16, wherein said memory stores a specific volume of data selected from the group of a transmission packet size, a reception packet size, a transmission packet count, and a reception packet count, in conjunction with a user identifier; and wherein said disconnection is performed when the data volume of a packet being a group of the same transmission/reception destination address exceeds said specific amount.

23 The communications method defined in claim 16, wherein said server is connected to an application server which stores an application supplied from a client terminal; and wherein said memory stores an address of said application server and a timeout time, in conjunction with a service identifier; said method further comprising the steps of monitoring an arrival time of a packet stored in said memory, said packet being a group of an address and a service identifier, and performing disconnection immediately before elapsing a timeout time from said arrival time, said timeout time being stored in said memory in conjunction with a service identifier, said memory belonging to a group of a matching address and a matching service identifier and with the timing a packet matching a group of an address and a service identifier is not received from an opposite party.

24 The communications method defined in claim 16, wherein a client terminal logged in at an earliest time is disconnected when two or more client terminals have the same disconnection condition.

25 The communications method defined in claim 16, wherein said memory stores a line disconnecting order in conjunction with a user identifier; and wherein said disconnection is performed in accordance with the order stored in said memory.

26 A server, which links to a client terminal based on a disconnection condition regarding disconnection of communications established between said server and a service user, said server comprising:
means for logging in to said client terminal in response to a log-in request from said client terminal;
a memory for storing disconnection condition regarding disconnection in conjunction with said user identifier;
retrieval means for retrieving said stored disconnection condition based on a user identifier transmitted from said client terminal; and
disconnection means for monitoring a connection state between said client terminal and said server and disconnecting said client terminal when said connection corresponds to said disconnection condition.

27 The server defined in claim 26, wherein said memory stores a time period between logging in and disconnection by a service user, in conjunction with a user identifier; and wherein said disconnection means comprises means for performing disconnection when a time period elapsed from a log-in operation to said server from said client terminal exceeds a time period stored in said memory.

28 The server defined in claim 26, wherein said memory stores a non-communication time period for which data is not transmitted or received in conjunction with a user identifier; and wherein said disconnection means comprises means for performing disconnection when a noncommunication time period of a client terminal exceeds said non-communication time period stored in said memory.

29 The server defined in claim 28, wherein said server is connected to an application server which stores an application supplied to a client terminal; wherein said non-communication time period is a time period for which a packet is not communicated between a client terminal and an application server; and wherein said disconnection means comprises means for monitoring an arrival time of a packet being a group of the same transmission destination address and the same reception destination address and performing disconnection when a time period elapsed from said arrival time exceeds a non-communication time period stored in said memory.

30 The server defined in claims 26, wherein said memory stores an allowable simultaneous jointer count which can be simultaneously connected to an access point or server, in conjunction with a user identifier; and wherein said disconnection means comprises means for performing disconnection when the number of jointers connected to an access point or server exceeds the allowable simultaneous jointer count stored in said memory.

31 The server defined in claim 26, wherein said memory stores an allowable traffic allowable in a predetermined period of time, in conjunction with a user identifier; and wherein said disconnection means comprises means for performing disconnection when said traffic exceeds an allowable traffic stored in said memory.

32 The server defined in claims 26, wherein said memory stores a specific volume of data selected from the group of a transmission packet size, a reception packet size, a transmission packet count, and a reception packet count, in conjunction with a user identifier; and wherein said disconnection means comprises means for performing disconnection when a data volume of a packet being a group of the same transmission/reception destination address exceeds said specific volume.

33 The server defined in claim 26, wherein said server is connected to an application server which stores an application supplied from a client terminal; and wherein said memory stores an address of said application server and a timeout time, in conjunction with a service identifier; and said disconnection means comprises means for monitoring an arrival time of a packet stored in said memory, said packet being a group of an address and a service identifier, and performing disconnection immediately before elapsing a timeout time from said arrival time, said timeout time being stored in said memory in conjunction with a service identifier, said memory belonging to a group of a matching address and a matching service identifier and with the timing a packet matching a group of an address and a service identifier is not received from an opposite party.

34 The server defined in claim 26, wherein said disconnection means comprises means for disconnecting a client terminal logged in at an earliest time when two or more client terminals have the same disconnection condition.

35 The server defined in claim 26, wherein said memory stores a line disconnecting order in conjunction with a user identifier; and wherein said disconnection means is means for performing disconnection in accordance with the order stored in said memory.

36 A recording medium in which a process program is stored, said process program controllably linking a server to a client terminal based on a disconnection condition regarding disconnection of communications established between said server and a service user, said process program comprising the steps of:
logging in to said client terminal in response to a log-in request from said client terminal;
retrieving, based on a user identifier transmitted from said client terminal, a disconnection condition stored in conjunction to said user identifier;
monitoring a connection state between said client terminal and said server; and
disconnecting said client terminal when said connection corresponds to said disconnection condition.

37 The recording medium defined in claim 36, wherein a process program is stored for performing said disconnection when a time period elapsed from the time at which said client terminal logs in to said server exceeds a time period between logging-in and disconnection, said time period being stored in conjunction with a user identifier of a service user.

38 The recording medium defined in claim 36, wherein a process program is stored for performing said disconnection when a non-communication time period of a client terminal exceeds a non-communication time period for which data stored in conjunction with a user identifier of a service user is not transmitted or received.

39 The recording medium defined in claim 38, wherein a process program is stored for monitoring an arrival time of a packet having a group of the same transmission/reception destination addresses and performing said disconnection when a non-communication time period exceeds from said arrival time a predetermined non-communication time period for which a packet is not communicated between said client terminal and said application server.

40 The recording medium defined in claim 36, wherein a process program is stored for performing said disconnection when the number of users connected to an access point or server exceeds an allowable simultaneous jointer count which is simultaneously connectable to an access point or server, said allowable simultaneous jointer count being stored in conjunction with a user identifier.

41 The recording medium defined in claim 36, wherein a process program is stored for performing said disconnection when said traffic exceeds an allowable traffic allowable in a predetermined time period, said allowable traffic being stored in conjunction with a user identifier.

42 The recording medium defined in claim 36, wherein a process program is stored for performing said disconnection when the data volume of a packet having a group of the same transmission/reception destination addresses exceeds a specific volume of data selected from the group of a transmission packet size, a reception packet size, a transmission packet count, and a reception packet count, each being stored in conjunction with a user identifier.

43 The recording medium defined in claim 36, wherein said server stores a process program in a system connected to an application server which stores an application supplied to a client terminal, said process program for monitoring an arrival time of a packet being a group of an address and a service identifier, said packet being stored as a group of an address and a service identifier, and performing said disconnection immediately before a stored timeout time elapses from said arrival time and with the timing a packet is not received from an opposite party.

44 The recording medium defined in claim 36, wherein a process program is stored for performing disconnection from a client terminal logged in at an earliest time when two or more client terminals have the same disconnection condition.

45 The recording medium defined in claim 36, wherein a process program is stored for performing said disconnection in accordance with an order stored in conjunction with a user identifier.
